(19) United States
(12) Patent Application Publication
(10) Pub. No.: US 2006/0008190 A1
(43) Pub. Date: Jan. 12, 2006

(54) Fluid dynamic bearing device

(75) Inventors: Tsutomu Hamada, Hirakata-shi (JP); Takafumi Asada, Hirakata-shi (JP)

Correspondence Address: WENDEROTH, LIND & PONACK, L.L.P., 2033 K STREET N. W., SUITE 800, WASHINGTON, DC, 20006-1021, US

(73) Assignee: MATSUSHITA ELECTRIC INDUSTRIAL CO., LTD.

(21) Appl. No.: 11/175,311

(22) Filed: Jul. 7, 2005

(30) Foreign Application Priority Data
Jul. 9, 2004 (JP) 2004-203942

(51) Int. Cl. F16C 32/06; C22C 38/36

(52) U.S. Cl. 384/100

(57) ABSTRACT

A fluid dynamic bearing device is disclosed in which, in the materials used for the sleeve of the fluid dynamic bearing device, particles of free-cutting elements and free-cutting alloys added to iron-based free-cutting steel, ferrite-based free-cutting stainless steel, and so on are reduced in size to about 0.1 to 0.5 μm. The result is smaller crystals of free-cutting alloy, and particularly manganese sulfide, on the inner peripheral face of the bearing hole of the sleeve made of free-cutting steel, which makes the inner peripheral face of the sleeve smoother. Also, the carbon content of free-cutting steel is kept to 0.1% or less, which lowers the hardness of the material and extends the service life of the tool used to cut the dynamic pressure generation grooves.

### BACKGROUND OF THE INVENTION

1. Field of the Invention

The present invention relates to a fluid dynamic bearing device that utilizes the dynamic pressure of a fluid.

2. Background Information

In recent years, recording devices that make use of a rotating recording medium, such as a magnetic disk, have been increasing in both memory capacity and data transmission speed. Consequently, the bearing devices of disks and the like used in this type of recording device need to rotate at high speed and high precision. It is for this reason that fluid dynamic bearing devices are used as bearing devices (see Japanese Laid-Open Patent Application H05-312212, for example).

A conventional fluid dynamic bearing device will now be described through reference to FIGS. 8 to 12.

FIG. 8 is a cross section of a typical conventional example of a spindle motor equipped with a fluid dynamic bearing device. The fluid dynamic bearing device is shown in the middle part of the drawing, and the spindle motor components are shown at the ends. In FIG. 8, a shaft 111 is rotatably inserted in a bearing hole 112a of a sleeve 112. The shaft 111 has a flange 113 formed integrally at the lower end in FIG. 8. The flange 113 is housed in a stepped portion of the sleeve 112, which is attached to a base 117, and the flange 113 is rotatably provided across from a thrust plate 114. A rotor hub 118 to which a rotor magnet 120 is fixed is attached to the shaft 111. A motor stator 119 located across from the rotor magnet 120 is attached to the base 117. Two sets of dynamic pressure generation grooves 112b in a herringbone pattern, which is well known in this field of technology, are provided to the inner peripheral face of the bearing hole 112a of the sleeve 112. A dynamic pressure generation groove 113a, which is similarly well known, is provided to the side of the flange 113 that is across from the stepped portion of the sleeve 112, and a dynamic pressure generation groove 113b is provided to the side of the flange 113 that is across from the thrust plate 114. Oil 130 fills the space between the sleeve 112, the flange 113, and the shaft 111, including the dynamic pressure generation grooves 112b, 113a, and 113b.

The operation of the conventional fluid dynamic bearing device structured as above will now be described.

In FIG. 8, when power to the motor stator 119 is switched on, a rotational magnetic field is generated and the rotor magnet 120, the rotor hub 118, the shaft 111, and the flange 113 begin to rotate. At this point pumping pressure is generated in the oil 130 by the dynamic pressure generation grooves 112b, 113a, and 113b, causing the shaft 111 and the flange 113 to float and rotate without coming into contact with the inner peripheral face of the bearing hole 112a and the thrust plate 114.

The shaft 111 rotates while being lubricated by the oil 130 filling the bearing hole 112a of the sleeve 112. As shown in the graph of FIG. 9, the viscosity of oil generally increases as an exponential function when the temperature drops. Since the rotational resistance incurred when the shaft 111 rotates is proportional to the viscosity of the oil, at low temperatures the rotational resistance of the shaft 111 is higher and loss torque increases, resulting in higher power consumption by the motor. Conversely, at high temperatures, the viscosity of the oil decreases, reducing the rotational resistance, but this also lowers the rigidity of the bearing of the fluid dynamic bearing device, which is proportional to the viscosity of the oil, so there is an increase in radial runout (a phenomenon whereby the shaft 111 vibrates in the bearing hole 112a during rotation). The “radial gap,” which is defined by the difference between the radius of the bearing hole 112a of the sleeve 112 and the radius of the shaft 111, is in theory inversely proportional to the cube of bearing rigidity, and inversely proportional to loss torque. At low temperatures, the radial gap between the bearing hole 112a and the shaft 111 is preferably larger in order to minimize the increase in loss torque accompanying an increase in oil viscosity. At high temperatures, the radial gap is preferably smaller in order to minimize the decrease in bearing rigidity accompanying a decrease in oil viscosity. To satisfy these conditions, the materials of the sleeve 112 and the shaft 111 are preferably selected as follows from the standpoint of the linear coefficient of expansion. The sleeve 112 may be made from a material whose linear coefficient of expansion is as small as possible, and the shaft 111 from a material whose linear coefficient of expansion is as large as possible.

Specific examples of common industrial materials that have a linear coefficient of expansion suited to the sleeve 112 are iron and alloys thereof, ferrite-based stainless steel, and martensite-based stainless steel, whose linear coefficients of expansion range from 10×10⁻⁶ to 12×10⁻⁶. A material that is suited to the shaft 111 is austenite-based stainless steel, whose linear coefficient of expansion is approximately 17×10⁻⁶. The three types of material listed above as examples of the material of the sleeve 112 all have extremely poor cuttability, so the common practice is to use what are known as iron-based free-cutting steel, ferrite-based free-cutting stainless steel, or martensite-based free-cutting stainless steel, which are obtained by adding various kinds of free-cutting elements or alloys thereof. Examples of free-cutting elements include lead, sulfur, tellurium, and selenium, while an example of an alloy of a free-cutting element is manganese sulfide. Free-cutting steel is generally produced by adding these free-cutting elements or alloys in as large an amount as possible to the base iron, ferrite-based stainless steel, or martensite-based stainless steel, and is manufactured so that the crystal size of the free-cutting elements or alloys will be as large as possible, in order to optimize the cuttability,

When the sleeve 112 is made from one of these free-cutting steels, first the free-cutting steel material is formed by cold rolling into a round rod whose diameter is slightly larger than the greatest outside diameter of the sleeve 112. This round rod is then turned on a lathe to produce the sleeve 112. The dynamic pressure generation grooves 112b are formed in a separate step after the lathe turning.

The following problems are encountered with a conventional fluid dynamic bearing device produced as above.

The first problem is that crystals of the free-cutting elements or alloys thereof appear on the surface of the bearing hole 112a that has been turned on a lathe (the dynamic pressure generation grooves 112b have yet to be formed at this point).

FIG. 10 is an enlarged photograph of the surface of the bearing hole 112a when the sleeve 112 was made from a low-carbon steel-based free-cutting steel corresponding to SUM 24 specified by the Japanese Industrial Standards (JIS). In this photograph the surface has been enlarged approximately 250 times with a digital microscope. The left and right direction in FIG. 10 is the axial direction of the bearing hole 112a, and the direction indicated by arrow 145 is the rotational direction of the sleeve 112 during the machining of the bearing hole 112a.

Regions 132, 133, 134, and 135, which extend in the left and right direction and are slightly darker in color, indicate the portions where the free-cutting elements sulfur and manganese have precipitated on the surface in the form of a manganese sulfide alloy. Regions 132 to 135 are from 0.07 to 0.15 mm long in the axial direction (left and right direction), and are about 0.01 mm long in the direction perpendicular to the axis (arrow 145). The reason the shape of the regions 132 to 135 is elongated to the left and right is that when the raw material is cold rolled into a round rod as discussed above, the crystals of manganese sulfide are also stretched out. The crystals of manganese sulfide are far larger than the radial gap between the shaft 111 and the bearing hole 112a, which is between 0.002 and 0.003 mm. A common feature of free-cutting steel is that the metal crystals of a free-cutting alloy are large, and the larger are the metal crystals, the better are the free-cutting properties of the material. In regions 132 to 135 where crystals of manganese sulfide have precipitated, the surface of the bearing hole 112a (FIG. 8) is rough, and there is the danger that the manganese sulfide crystals will fall out after assembly into a fluid dynamic bearing, bake onto the inner surface of the bearing hole 112a during rotation, and make rotation impossible.

In FIG. 10, the face of the bearing hole 112a has been machined with a cutting tool (not shown) that passes in the direction of arrow 145 of a lathe. The cutting tool alternately cuts regions 137 of low-carbon steel (the base material) and regions 132 of manganese sulfide crystals (free-cutting alloy). Low-carbon steel has higher strength and toughness than manganese sulfide crystals. Specifically, manganese sulfide crystals are lower in strength and more brittle than low-carbon steel. Therefore, when the region 137 of low-carbon steel is machined with a cutting tool, the cutting marks left by the tool form a continuous cutting line in the up and down direction, as shown by 140, for example, but in the region 132 of manganese sulfide crystals there are almost no cutting marks, the result instead being a fracture plane. Accordingly, the cutting resistance of the tool is higher in the region 137 of low-carbon steel, and lower in the regions 132 to 135 of manganese sulfide crystals. As a result, the tool vibrates, and surface roughness increases in the region 137 of low-carbon steel as well.

FIG. 11 is an example of measuring the surface roughness when SUM 24 was used as the material of the sleeve 112 and the bearing hole 112a of the sleeve 112 was turned on a lathe. The horizontal axis in FIG. 11 is the axial direction of the bearing hole 112a (the distance between the two arrows is 0.1 mm), and the vertical axis is the size of the bumps, which indicates the roughness (the distance between the two arrows is 0.0002 mm). FIG. 11 gives the measurement results obtained using a Form Talysurf Series 2 made by Taylor-Hobson.

In general, the radial gap between the shaft 111 and the bearing hole 112a is from 0.002 to 0.003 mm. If an attempt is made to make the bearing rigidity when the roughness is zero be the same as the bearing rigidity when roughness is taken into account, the radial gap will be the gap between the outer periphery of the shaft 111 and an average location on a bumpy surface. In the case of FIG. 11, the maximum width of the bumps is about 0.001 mm. The substantial minimum radial gap between the bearing hole 112a and the shaft 111 is from 0.0015 to 0.0025 mm, which is smaller than the range given above by one-half of the 0.001 mm maximum width of the bumps. In this state, the shaft 111 and the bearing hole 112a come into contact with the tops of the bumps, making the occurrence of seizure extremely likely. With the conventional bearing hole 112a of the sleeve 112, polishing or other such after-working or after-treatment was essential in order to reduce the roughness after lathe turning, but the problem with this was that it drove up the cost.

Another problem arising from manganese sulfide crystals is that some of these crystals fall out during the use of the completed product in which the fluid dynamic bearing has been assembled by inserting the shaft 111 into the bearing hole 112a of the sleeve 112, and this can cause the fluid dynamic bearing to seize. As described through reference to FIG. 10 above, that almost no cutting line is produced by the cutting tool on the manganese sulfide of regions 132 to 135 indicates that the manganese sulfide crystals are fractured and removed by the tool. Specifically, when struck by the tool, the manganese sulfide crystals crack, fall off, and are removed. It is estimated that a single manganese sulfide crystal 132 cracks a number of times equal to the number of cutting lines remaining in the region 137 of low-carbon steel, and the fragments produced by this cracking fall off. Accordingly, microscopic manganese sulfide crystals that have become independent through cracking are present on the surface of a large manganese sulfide crystal, and there is the danger that these may fall off during the use of the product after its assembly.

The inventors conducted various experiments, and found that when a fluid dynamic bearing device is made using a sleeve 112 such as this, microscopic manganese sulfide crystals fall out during use and get into the bearing gap, which makes it extremely likely that the bearing will seize. The SUM 24 material used in this conventional example is sometimes subjected to electroless nickel plating in a thickness of about 0.002 to 0.005 mm in an effort to improve rust resistance or wear resistance. This plating does prevent the microscopic manganese sulfide crystals from falling out to a certain extent, and reduces the likelihood of seizure, but it cannot prevent seizure completely. Because only large manganese sulfide crystals are likely to fall out when the material containing these crystals is cut, a thin plating is not strong enough to adequately prevent the crystals from falling out. In the conventional example given above, the description was of a case in which low-carbon steel-based free-cutting steel (SUM 24) was used for the material of the sleeve, but since manganese sulfide crystals are usually present when ferrite-based free-cutting stainless steel or martensite-based free-cutting stainless steel is used, the same problems occur with these materials as well.

The second problem will now be described. FIG. 12 illustrates a method for machining the dynamic pressure generation grooves 112b on the inner peripheral face of the bearing hole 112a of the sleeve 112 shown in FIG. 8. In FIG. 12 the sleeve 112 is shown in cross section. A known groove rolling tool 122 for the plastic working of the dynamic pressure generation grooves 112b is made up of a shank 123, a plurality of rolling balls 124, and a holder 125 for fixing the rolling balls 124 and the shank 123. The diagonal length L of the rolling balls 124 is set to be greater than the inside diameter of the bearing hole 112a of the sleeve 112 by a length corresponding to the depth of the dynamic pressure generation grooves 112b. When the dynamic pressure generation grooves 112b are to be formed, the groove rolling tool 122 is inserted into the sleeve 112 in the direction of arrow Z while being rotated in the direction of arrow A relative to the sleeve 112. This forms the angled portion 142a of the dynamic pressure generation grooves 112b. The angled portion 142b that follows after the vertex of the dynamic pressure generation grooves 112b is formed by further inserting the groove rolling tool 122 in the arrow Z direction while rotating it in the opposite direction from that of arrow A. This creates one of the V-shaped dynamic pressure generation grooves 112b. The second and subsequent V-shaped grooves are formed in the same way. When the groove rolling tool 122 is to be withdrawn from the sleeve 112, it can either be withdrawn by retracing its path during insertion, or twice as many dynamic pressure generation grooves 112b as there are rolling balls 124 can be formed by passing through the middle part of the grooves formed during insertion.

Wear to the rolling balls 124 is inevitable because the balls are constantly rubbing against the inner walls of the bearing hole 112a of the sleeve 112 during the machining of the dynamic pressure generation grooves 112b. When the rolling balls 124 wear down, the dynamic pressure generation grooves 112b become shallower in depth, so there is a decrease in the performance of the fluid dynamic bearing. To prevent wear, the material of the rolling balls 124 is optimally selected from among special materials such as bearing steel, ceramics, or metal materials that are generally called carbides. However, when the material of the sleeve 112 is SUM 24, the service life of the rolling balls 124 of the groove rolling tool 122 is long enough to machine approximately 5000 sleeves 112. This is a problem in that the cost of machining the dynamic pressure generation grooves 112b is high. The high hardness of the material from which the sleeve 112 is made is the reason for the shorter service life of the rolling balls 124. Iron-based free-cutting steel, ferrite-based free-cutting stainless steel, and martensite-based free-cutting stainless steel usually contain from 0.1 to 0.5% carbon. Roughly 80% of this martensite-based free-cutting stainless steel is iron. Thus combining carbon with iron results in a pearlite structure of high strength and hardness. Because of the high hardness, though, it is disadvantageous in terms of the wear of the rolling balls 124.

In view of the above, there exists a need for a fluid dynamic bearing device and a spindle motor which overcomes the above mentioned problems in the prior art, and which provides high reliability at a low cost. This invention addresses this need in the prior art as well as other needs, which will become apparent to those skilled in the art from this disclosure.

### SUMMARY OF THE INVENTION

The fluid dynamic bearing device of the present invention has a sleeve and a shaft that is relatively rotatably inserted in a bearing hole of the sleeve, in which a radial bearing face having a dynamic pressure generation groove is provided to the outer peripheral face of the shaft and/or to the inner peripheral face of the sleeve, and the space between the shaft and the bearing hole of the sleeve is filled with a lubricant as a working fluid. The sleeve is made from at least one kind of material selected from among iron-based free-cutting steel, ferrite-based free-cutting stainless steel, and martensite-based free-cutting stainless steel, the length, in the axial direction of the bearing hole of the sleeve, of crystals of the free-cutting elements and free-cutting element alloys contained in each free-cutting steel is less than 0.03 mm, and the width in a direction perpendicular to the axial direction is less than 0.005 mm.

With the present invention, the length, in the axial direction of the bearing hole of the sleeve, of crystals of the free-cutting elements and free-cutting element alloys contained in each free-cutting steel is less than 0.03 mm, and the width in a direction perpendicular to the axial direction is less than 0.005 mm, and as a result, there are almost no fracture planes when the inner peripheral face of the bearing hole of the sleeve is turned on a lathe. Accordingly, there is less surface roughness (bumps) after cutting, and a better cut surface can be obtained. The result is that there is no danger that crystals of free-cutting elements or free-cutting alloys will fall out during the use of the fluid dynamic bearing and make it impossible for the fluid dynamic bearing device to rotate.

Another aspect of the fluid dynamic bearing device of the present invention is a fluid dynamic bearing device having a sleeve and a shaft that is relatively rotatably inserted in a bearing hole of the sleeve, in which a radial bearing face having a dynamic pressure generation groove is provided to the outer peripheral face of the shaft and/or to the inner peripheral face of the sleeve, and the space between the shaft and the bearing hole of the sleeve is filled with a lubricant as a working fluid. The sleeve is made from at least one kind of material selected from among iron-based free-cutting steel, ferrite-based free-cutting stainless steel, and martensite-based free-cutting stainless steel, the carbon content of the free-cutting steel is less than 0.1 wt %, and the hardness Hv (Vickers hardness) of the components formed from these materials is less than 230.

With the present invention, the effect of keeping the carbon content of each free-cutting steel (the material of the sleeve) under 0.1% is that there is a significant reduction in the hard pearlite structure with a Vickers hardness Hv of 500 or higher, which originates in carbon, to the point that substantially no such structure is present. Accordingly, there is much less wear to the rolling balls that form the dynamic pressure generation grooves in the plastic working of the bearing hole of the sleeve.

With the present invention, the size of the crystals of free-cutting elements and alloys thereof contained in free-cutting steel, ferrite-based free-cutting stainless steel, or martensite-based free-cutting stainless steel is kept small, which reduces the surface roughness of the bearing hole of the sleeve. There is therefore no need for an after-step for reducing surface roughness, which lowers the cost. Also, this lower surface roughness reduces the likelihood that crystals of free-cutting elements will fall out, something which tends to occur during use after the assembly of the fluid dynamic bearing device is completed, so the resulting fluid dynamic bearing device is more reliable.

Moreover, the carbon content in the free-cutting steel, ferrite-based free-cutting stainless steel, and martensite-based free-cutting stainless steel is kept under 0.1%, and the Vickers hardness Hv of the rod stock of these materials is kept to 230 or less, which greatly extends the service life of the groove rolling tool, and this in turn affords a fluid dynamic bearing device that can be manufactured less expensively.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a cross section of a spindle motor having a fluid dynamic bearing device according to a first embodiment of the present invention;

FIG. 2 is an enlarged photograph of the surface of a bearing hole of the sleeve in the first embodiment of the present invention;

FIG. 3 shows the results of measuring the surface roughness of the bearing hole of a sleeve in the first embodiment of the present invention;

FIG. 4 is a graph of the relation between the length of free-cutting element crystals and the size of the bumps (surface roughness);

FIG. 5 is a side view of a working apparatus, and illustrates the process of forming dynamic pressure generation grooves according to a second embodiment of the present invention;

FIG. 6 is a graph of the relation between the carbon content of the sleeve material and the amount of change in the diagonal length L of the rolling balls;

FIG. 7 is a graph of the relation between the surface hardness of the bearing hole of the sleeve and the amount of change in the diagonal length L;

FIG. 8 is a cross section of a spindle motor having a conventional fluid dynamic bearing device;

FIG. 9 is a graph of the relation between temperature and oil viscosity;

FIG. 10 is an enlarged photograph of the surface of the bearing hole of a sleeve in a conventional example;

FIG. 11 shows the results of measuring the surface roughness of the bearing hole of a sleeve in a conventional example; and

FIG. 12 is a side view of a working apparatus, illustrating the process of plastically working dynamic pressure generation grooves in a conventional example.

### DETAILED DESCRIPTION OF THE PREFERRED EMBODIMENTS

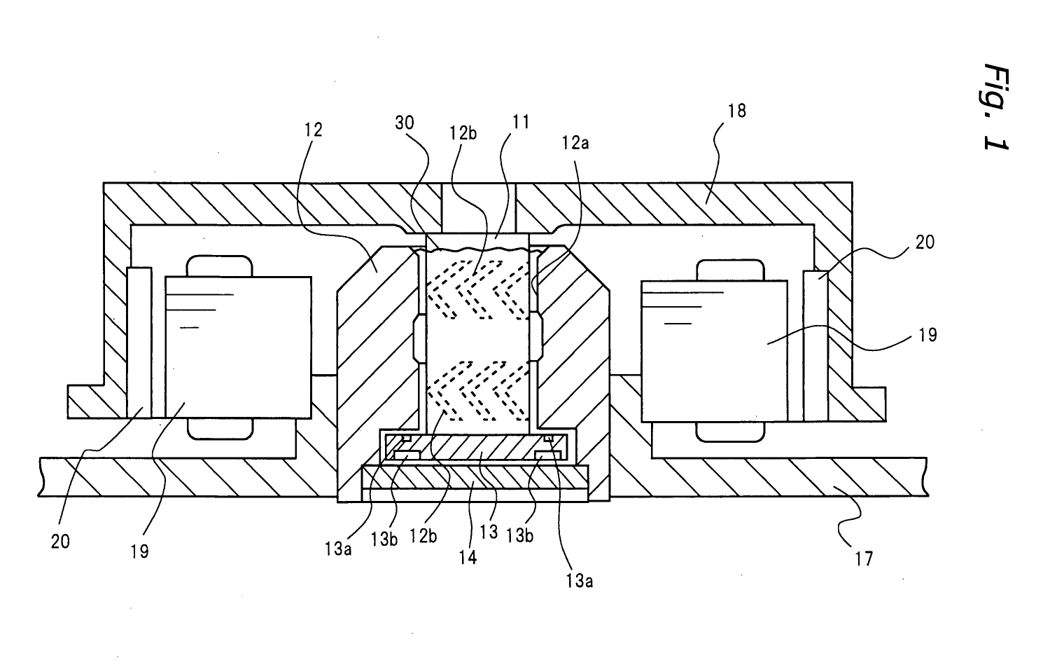

Preferred embodiments of the fluid dynamic bearing device of the present invention will now be described through reference to FIGS. 1 to 7.

### First Embodiment

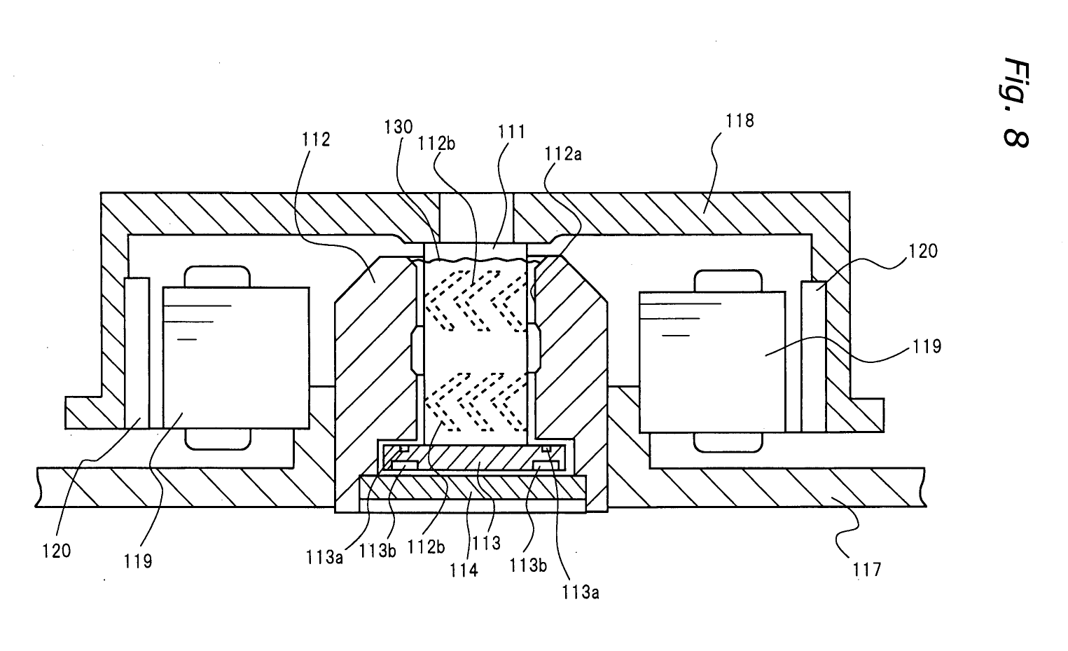

The fluid dynamic bearing device of the first embodiment of the present invention will be described through reference to FIGS. 1 to 4. The present invention relates mainly to the material of the sleeve of a fluid dynamic bearing. FIG. 1 illustrates a fluid dynamic bearing device that is substantially the same in structure as the conventional fluid dynamic bearing device shown in FIG. 8, except that the various elements are numbered differently. In FIG. 1, a shaft 11 is rotatably inserted in a bearing hole 12a of a sleeve 12. The shaft 11 has a flange 13 formed integrally at the lower end in FIG. 1. The flange 13 is housed in a stepped portion of the sleeve 12, which is attached to a base 17, and the flange 13 is rotatably provided across from a thrust plate 14. A rotor hub 18 to which a rotor magnet 20 is fixed is attached to the shaft 11. A motor stator 19 located across from the rotor magnet 20 is attached to the base 17. Dynamic pressure generation grooves 12b are provided to the inner peripheral face of the bearing hole 12a of the sleeve 12. A dynamic pressure generation groove 13a is provided to the side of the flange 13 that is across from the stepped portion of the sleeve 12, and a dynamic pressure generation groove 13b is provided to the side of the flange 13 that is across from the thrust plate 14. Oil 30 fills the space between the sleeve 12, the flange 13, and the shaft 11, including the dynamic pressure generation grooves 12b, 13a, and 13b.

The operation of the fluid dynamic bearing device of the present invention constituted as above is exactly the same as in the conventional example, but will be described through reference to FIG. 1. In FIG. 1, when power to the motor stator 19 is switched on, a rotational magnetic field is generated and the rotor magnet 20, the rotor hub 18, the shaft 11, and the flange 13 begin to rotate. At this point pumping pressure is generated in the oil 30 by the dynamic pressure generation grooves 12b, 13a, and 13b, causing the shaft 11 and the flange 13 to float and rotate without coming into contact with the inner peripheral face of the bearing hole 12a and the thrust plate 14.

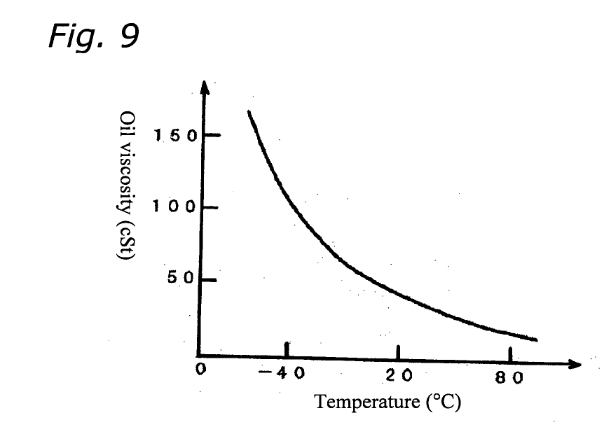

The shaft 11 rotates while being lubricated by the oil 30 filling the bearing hole 12a of the sleeve 12. As shown in the graph of FIG. 9, the viscosity of oil generally increases as an exponential function when the temperature drops. Since the rotational resistance incurred when the shaft 11 rotates is proportional to the viscosity of the oil, at low temperatures the rotational resistance of the shaft 11 is higher and loss torque increases, resulting in higher power consumption by the motor. Conversely, at high temperatures, the viscosity of the oil decreases, reducing the rotational resistance, but this also lowers the rigidity of the bearing of the fluid dynamic bearing device, which is proportional to the viscosity of the oil, so there is an increase in radial runout (a phenomenon whereby the shaft 11 vibrates in the bearing hole 12a during rotation). The “radial gap,” which is defined by the difference between the radius of the bearing hole 12a of the sleeve 12 and the radius of the shaft 11, is in theory inversely proportional to the cube of bearing rigidity, and inversely proportional to loss torque.

At low temperatures, the radial gap is preferably larger in order to prevent the increase in loss torque accompanying an increase in oil viscosity. At high temperatures, the radial gap is preferably smaller in order to prevent the decrease in bearing rigidity accompanying a decrease in oil viscosity. To satisfy these conditions, the sleeve 12 is preferably made from a material whose linear coefficient of expansion is as small as possible, and the shaft 11 from a material whose linear coefficient of expansion is as large as possible. Examples of common industrial materials that have a linear coefficient of expansion suited to the sleeve 12 are iron and alloys thereof, ferrite-based stainless steel, and martensite-based stainless steel, whose linear coefficients of expansion range from 10×10⁻⁶ to 12×10⁻⁶. A material that is suited to the shaft 11 is austenite-based stainless steel, whose linear coefficient of expansion is approximately 17×10⁻⁶. Lead, sulfur, manganese, or the like is added as a free-cutting element to the three types of material listed above as examples of the material of the sleeve 12. A free-cutting alloy such as lead and sulfur, or an alloy in which tellurium, selenium, or another such free-cutting element has been added to lead and sulfur, may also be added. This gives iron-based free-cutting steel, ferrite-based free-cutting stainless steel, or martensite-based free-cutting stainless steel.

In the case of an iron-based free-cutting steel, for example, the material used for the sleeve 12 in this embodiment can be one obtained by adding a tiny amount (no more than 1 wt %) of niobium to a material having substantially the same composition as SUM 24, which is a steel material specified by JIS. When niobium is added, it disperses uniformly in the iron-based free-cutting steel, and crystals of manganese sulfide grow in a smaller size around these niobium nuclei. Titanium may be added in the same way, and is believed to have a similar action and effect. The addition of niobium or titanium to iron-based free-cutting steel is known technology in this field. The present invention relates to the use of free-cutting steel containing small crystals of free-cutting elements or alloys thereof, and the means for obtaining this free-cutting steel is not limited to the addition of niobium or titanium. These free-cutting steel materials are formed ahead of time by cold rolling into a round rod whose diameter is slightly larger than the maximum outside diameter of the sleeve 12, so that the material can be worked into the shape of the sleeve 12 in less time. This round rod is cut on a lathe to produce the sleeve 12. The dynamic pressure generation grooves 12b are formed after this lathe turning.

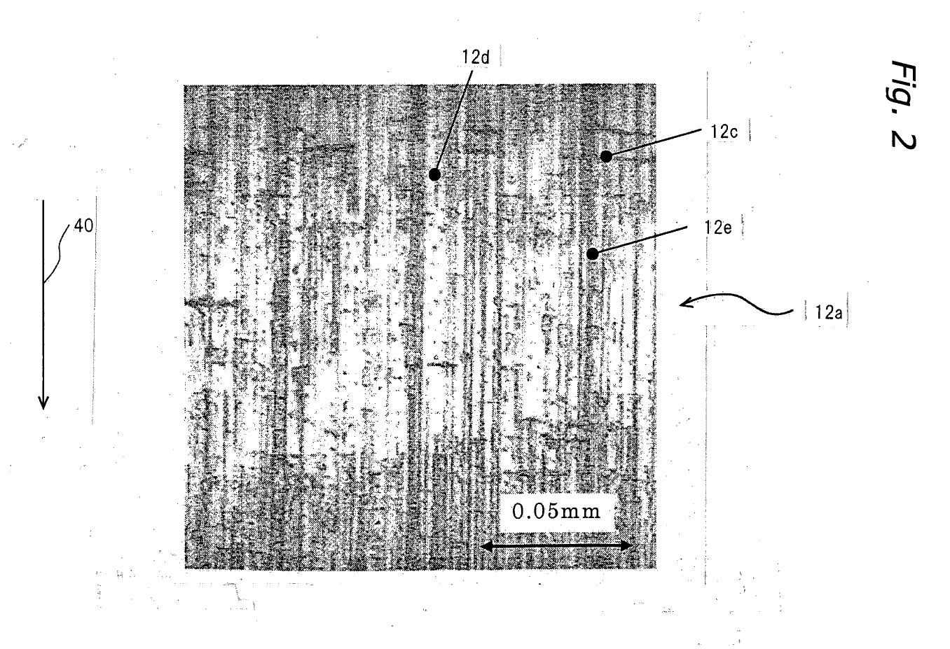

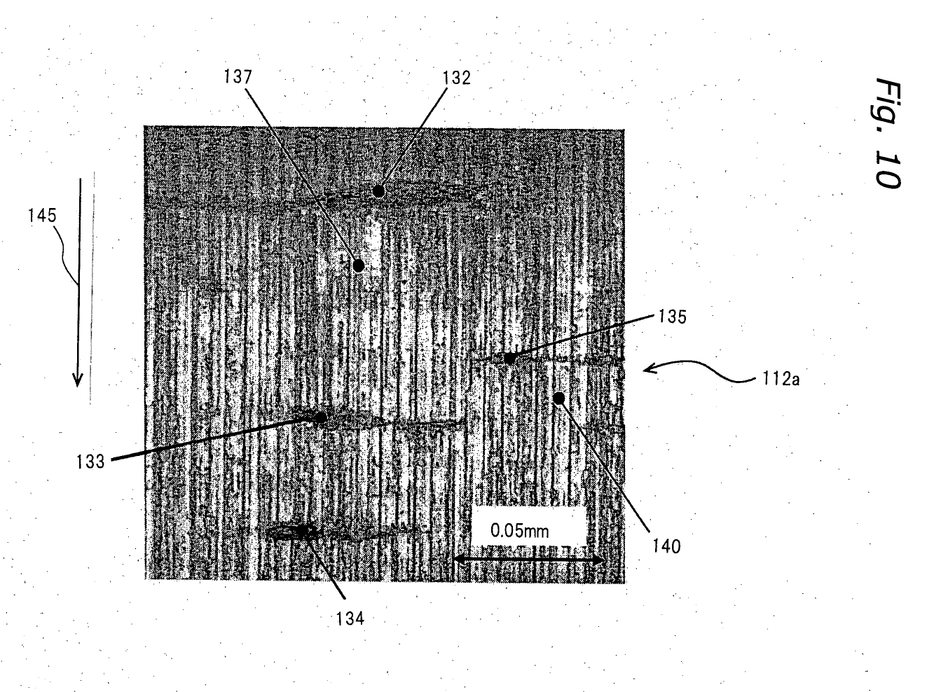

The iron-based free-cutting steel, ferrite-based free-cutting stainless steel, or martensite-based free-cutting stainless steel that is the material of the sleeve 12 of the fluid dynamic bearing device in this embodiment is characterized in that the size of the crystals of free-cutting elements or alloy thereof is smaller than in the past when the above-mentioned niobium, titanium, or the like was added. FIG. 2 is an enlarged photograph of the surface of the bearing hole 12a when the sleeve 12 was made from a carbon steel-based free-cutting steel to which niobium, titanium, or the like had been added (SUM), and was turned on a lathe. The left and right direction in FIG. 2 is the axial direction of the bearing hole 12a, and the direction indicated by arrow 40 is the rotational direction of the cutting tool. The somewhat darker horizontal region indicated by the black circle 12c is a crystal of manganese sulfide. The lighter area indicated by the black circle 12d is low-carbon steel (the base material). The black circle 12e indicates a cutting line produced by the cutting tool. The manganese sulfide region 12c is about 0.01 to 0.03 mm long and about 0.005 mm wide. When the region 12c is compared to the region 132 in the enlarged photograph of the surface of the bearing hole 112a of the sleeve 112 in the conventional example shown in FIG. 10, the region 12c is far smaller than the region 132.

In FIG. 2, the face of the bearing hole 12a has been machined with a cutting tool (not shown) that moves in the direction of arrow 40. The cutting tool alternately cuts regions 12d of low-carbon steel (the base material) and regions 12c of manganese sulfide crystals (free-cutting alloy). The regions 12d of low-carbon steel have higher strength and toughness than the regions 12c of manganese sulfide, and conversely, the regions 12c of manganese sulfide are lower in strength and more brittle than the regions 12d of low-carbon steel. Therefore, when the region 12d of low-carbon steel is machined with a cutting tool, the cutting marks 12e extend continuously in the up and down direction. Close observation by the inventor has revealed that there are places in the manganese sulfide regions 12c where the cutting lines 12e are continuous from the low-carbon steel regions 12d to the manganese sulfide regions 12c, and the well-defined fracture planes seen in the conventional example were not noted. Based on the above, in this embodiment, there is extremely little difference in the resistance encountered by the cutting tool when the tool cut the low-carbon steel regions and when the manganese sulfide regions 12c fractured, so there was less vibration of the tool.

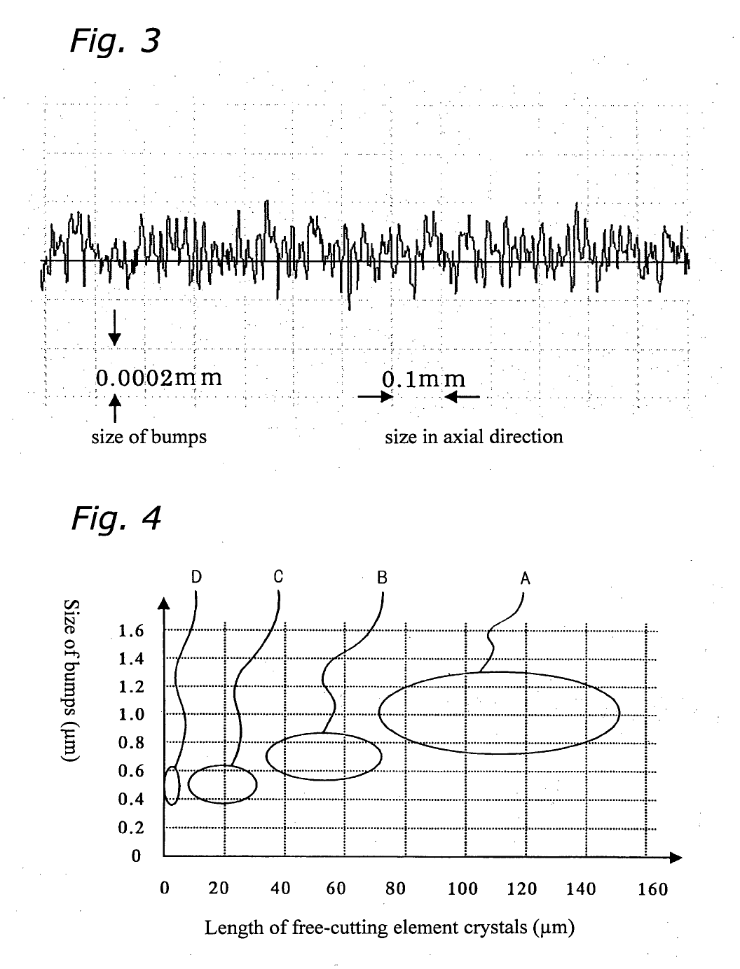

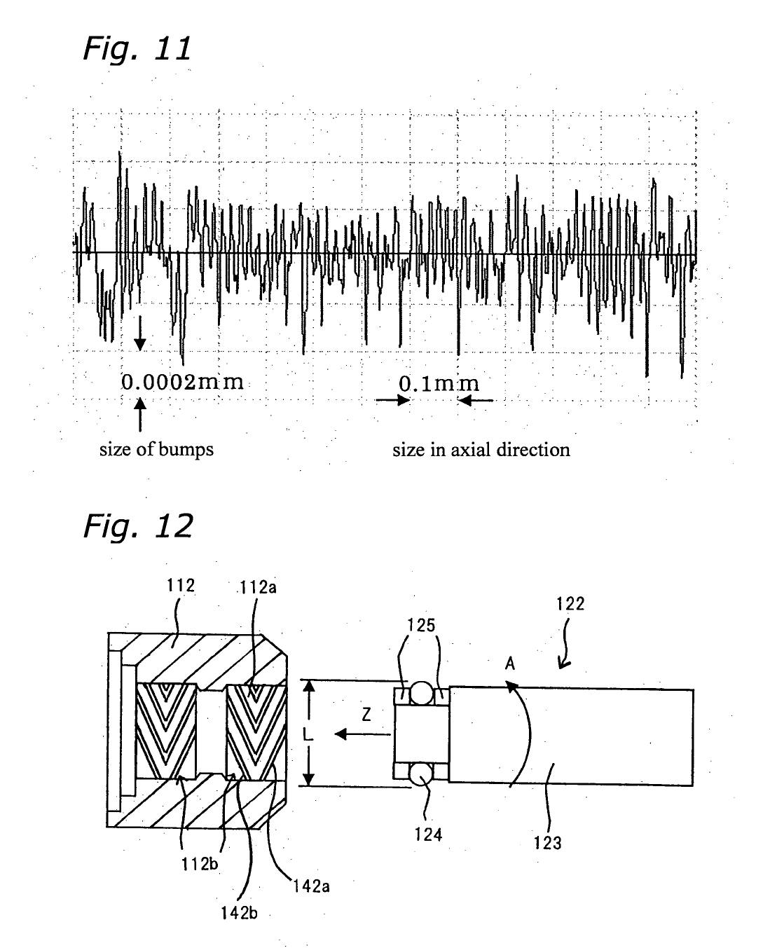

FIG. 3 shows the results of measuring the surface roughness (bumps) on the inner peripheral face of the bearing hole 12a of the sleeve 12 using the same apparatus as in FIG. 11. It can be seen from FIG. 3 that the size of the bumps was reduced to about 0.0005 mm. This is approximately one-half the size of the bumps in the conventional example shown in FIG. 10.

FIG. 4 is a graph of the results of measuring surface roughness when the sleeve 12 was made from four different materials of different length of the free-cutting element crystals, and the surface of the bearing hole 12a was machined. The horizontal axis is the length of the crystals of free-cutting elements, and the vertical axis is the size of the bumps, which indicates the surface roughness after machining. The oval A indicates the distribution of surface roughness when using the SUM of the conventional example, in which the length of manganese sulfide crystals ranged from 70 to 150 μm, and the size of the bumps was between 0.7 and 1.3 μm. Similarly, the oval B indicates the distribution of surface roughness when using an SUM equivalent material in which the length of manganese sulfide crystals was reduced to about 50 μm by a specific heat treatment. The oval C indicates the surface roughness when using an SUM equivalent material in which the length of free-cutting element crystals (the material of the sleeve 12 in this embodiment) was about 20 μm, and the size of the bumps was between 0.4 and 0.6 μm. The oval D indicates the surface roughness when using an iron-based free-cutting steel in which the length of the free-cutting element (including only lead, and not including manganese sulfide) was about 3 μm. The size of the ovals indicates the range of variance in surface roughness and the range of variance in the size of the crystals of free-cutting element or alloy. It can be seen from FIG. 4 that regardless of the type of free-cutting element, if the length of crystals of free-cutting element or alloy thereof is less than 30 μm, the bumps indicating surface roughness will be 6 μm or smaller, and a good machined face can be obtained. This eliminates the need for a step to improve the roughness after cutting, and lowers the cost of machining the sleeve 12.

The seizure of the fluid dynamic bearing that happens when manganese sulfide crystals 12c fall out, which occurs during use after the assembly of the fluid dynamic bearing device is completed, will now be described. With the sleeve 12 in this embodiment, as can be seen from FIG. 2, the width of the manganese sulfide crystals 12c (the size in the up and down direction in the drawing) is only about 0.005 mm. With manganese sulfide crystals 12c of this width, both sides thereof are securely supported by the low-carbon steel crystals 12d. Therefore, cracks are unlikely to form even upon impact from the cutting tool during machining, which greatly reduces the probability that the manganese sulfide crystals 12c will fall out. In the unlikely event that the manganese sulfide crystals should fall out, there is a low probability that the crystals will be larger than the 0.002 to 0.003 mm radial gap.

The inventor conducted various experiments, which revealed that when a material is used in which the length of the manganese sulfide crystals 12c is less than 0.03 mm and the width is less than 0.005 mm, the probability that the bearing will seize is less than 1/10 that with conventional materials. Furthermore, it should go without saying that the fallout of the manganese sulfide crystals 12c can be suppressed even more effectively if the material is subjected to electroless nickel plating for the purpose of improving rust resistance or wear resistance. In this embodiment, the description was of the manganese sulfide crystals 12c, which are the largest crystals of the various free-cutting elements and alloys thereof, but the same effect is obtained with a free-cutting steel in which other free-cutting elements or alloys are used. Since manganese sulfide-based alloys are generally contained in martensite-based free-cutting stainless steel and ferrite-based free-cutting stainless steel, in addition to the iron-based free-cutting steel used in the above description, the effect will be the same as in this embodiment.

As is clear from the above description, with the present invention, when an iron-based free-cutting steel, ferrite-based free-cutting stainless steel, or martensite-based free-cutting stainless steel is used as the material for a sleeve, a fluid dynamic bearing device with high reliability can be obtained at low cost by using a material in which the length of the crystals of free-cutting element or alloy is no more than 0.03 mm and the width is less than 0.005 mm.

### Second Embodiment

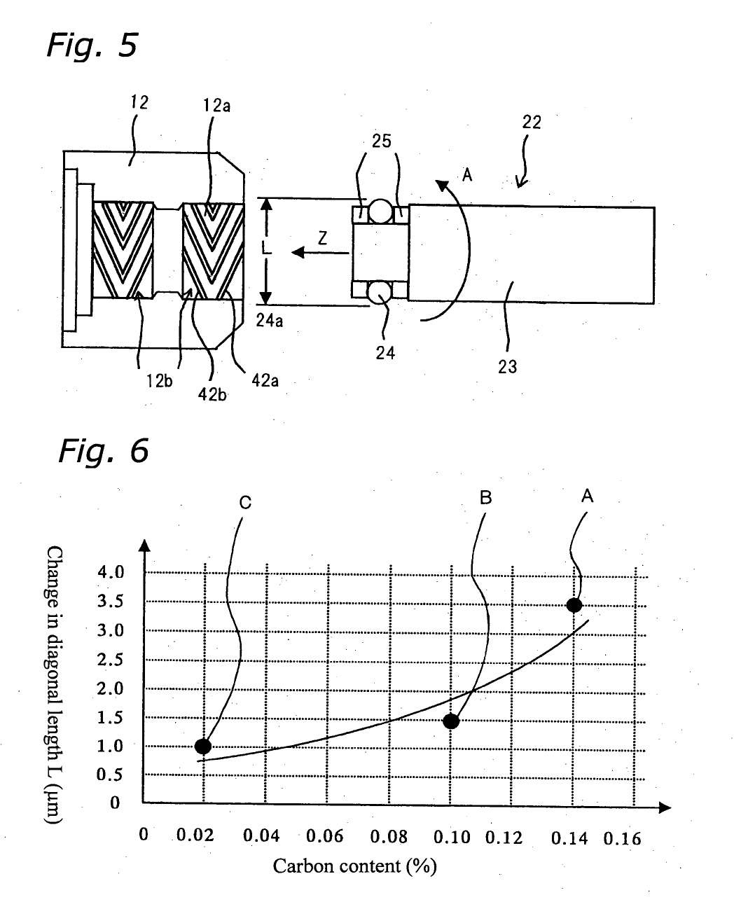

The fluid dynamic bearing device of the second embodiment of the present invention will be described through reference to FIGS. 5 to 7. This second embodiment relates to the material of the sleeve 12, and more particularly relates to the hardness of the material.

The step of forming the dynamic pressure generation grooves 12b on the inner peripheral face of the bearing hole 12a of the sleeve 12 in the first embodiment is performed using the apparatus shown in FIG. 5, which has substantially the same structure as the apparatus shown in FIG. 12 and described in the “Background Art” section. In FIG. 5, a known groove rolling tool 22 for the plastic working of the dynamic pressure generation grooves 12b is made up of a shank 23, a plurality of rolling balls 24, and a holder 25 for holding the rolling balls 24 on the shank 23. The diagonal length L of the rolling balls 24 is set to be greater than the inside diameter of the bearing hole 12a of the sleeve 12 by a length corresponding to the depth of the dynamic pressure generation grooves 12b. When the dynamic pressure generation grooves 12b are to be formed, the groove rolling tool 22 is inserted into the sleeve 12 in the direction of arrow Z while being rotated in the direction of arrow A relative to the sleeve 12. This forms the angled portion 42a of the dynamic pressure generation grooves 12b. The angled portion 42b that follows after the vertex of the dynamic pressure generation grooves 12b is formed by further inserting the groove rolling tool 22 in the arrow Z direction while rotating it in the opposite direction from that of arrow A. This creates one of the V-shaped dynamic pressure generation grooves 12b. The second and subsequent V-shaped grooves are formed in the same way. When the groove rolling tool 22 is to be withdrawn from the sleeve 12, it can either be withdrawn by retracing its path during insertion, or twice as many dynamic pressure generation grooves 12b as there are rolling balls 24 can be formed by passing through the middle part of the grooves formed during insertion.

Wear to the rolling balls 24 is inevitable because the balls are constantly rubbing against the inner walls of the bearing hole 12a of the sleeve 12 during the machining of the dynamic pressure generation grooves 12b. When the rolling balls 24 wear down, the dynamic pressure generation grooves 12b become shallower in depth, so there is a decrease in the performance of the fluid dynamic bearing. To prevent wear, the material of the rolling balls 24 is optimally selected from among special materials such as bearing steel, carbides, or ceramics. In this embodiment, the sleeve 12 is made of as soft a material as possible in order to prevent the wear of the rolling balls 24.

If the carbon content of the iron-based free-cutting steel, ferrite-based free-cutting stainless steel, or martensite-based free-cutting stainless steel is less than 0.1 wt%, the material will be soft, and there will be a significant reduction in pearlite structure attributable to carbon, to the point that substantially no such structure is present. The inventor conducted a test in which sleeves 12 were made using three types of material, namely, SUM containing approximately 0.14% carbon (material 1; the material in the conventional example), an SUM-equivalent material containing approximately 0.1% carbon (material 2), and pure iron-based lead free-cutting steel containing 0.02% carbon (material 3), and grooves were machined in 10,000 of each of these sleeves 12 using the groove rolling tool 22 shown in FIG. 5.

FIG. 6 shows the results of measuring the amount of change in the diagonal length L of the rolling balls 24 after the machining of grooves in 10,000 sleeves 12. The horizontal axis in FIG. 6 is the carbon content, black circle A is material 1, black circle B is material 2, and black circle C is material 3. It can be seen from FIG. 6 that the lower the carbon content, the less change there is in the diagonal length L and the less were there is to the rolling balls 24. It was confirmed that if the carbon content is less than 0.2%, the change in the diagonal length L is 1.5 μm or less, which means that the service life of the rolling balls 24 is adequate for practical purposes. The iron-based free-cutting steel, ferrite-based free-cutting stainless steel, or martensite-based free-cutting stainless steel that serves as the material of the sleeve 12 is pre-worked by cold rolling into a round rod whose diameter is slightly larger than the greatest outside diameter of the sleeve 12, so that the material can be worked into the shape of the sleeve 12 in less time. This pre-working increases the hardness of the material. For instance, the Vickers hardness Hv of pure iron is roughly 100, but after cold rolling the Vickers hardness Hv is about 200 to 300. The surface hardness of the bearing holes 12a of the sleeves 12 made from three different materials (the above-mentioned materials 1, 2, and 3) was measured, which revealed a Vickers hardness Hv of 280, 230, and 200, respectively.

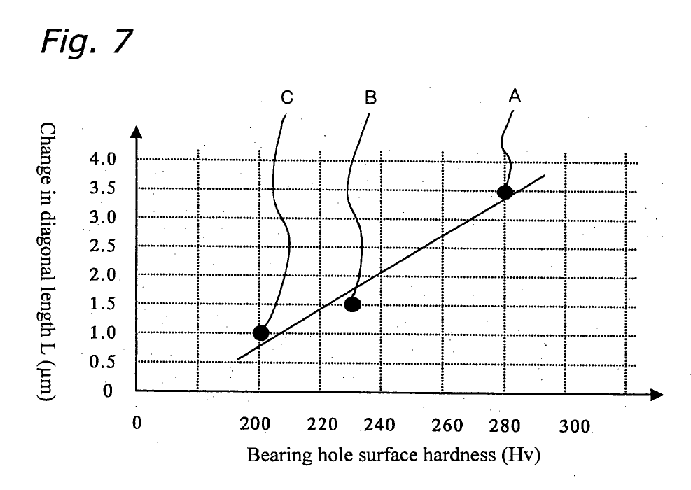

FIG. 7 is a graph of the relation between the Vickers hardness Hv of the surface of the bearing hole 12a and the amount of change in the diagonal length L. It can be seen from FIG. 7 that when the surface hardness of the bearing hole 12a is low, there is little change in the diagonal length L, and there is little wear to the rolling balls 24. FIG. 7 also shows that when the sleeve 12 is made from a material with a carbon content of less than 0.1%, which has been formed into a round rod and which has a Vickers hardness Hv of 230 or less, there is less wear to the rolling balls 24 in the machining of the dynamic pressure generation grooves of the bearing hole 12a (FIG. 5), and the reduction in the diagonal length L after the machining of grooves in 10,000 sleeves 12 can be kept to 1.5 μm or less. Specifically, compared to the SUM used in the conventional example, in which the carbon content was 0.14% and the Vickers hardness Hv was 280 (material 1), the service life of the rolling balls 24 can be extended by at least double.

As above, with this embodiment, the carbon content of iron-based free-cutting steel, ferrite-based free-cutting stainless steel, or martensite-based free-cutting stainless steel is kept under 0.1%, and the Vickers hardness Hv of the material of the sleeve 12 (in the form of a round rod made from the above material) is kept to 230 or less, the result of which is a reduction in the cost of working dynamic pressure generation grooves, and this in turn allows a lower cost fluid dynamic bearing device to be attained.

The fluid dynamic bearing device pertaining to the present invention has high reliability and is low in cost, and can be utilized in equipment requiring high reliability.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. A fluid dynamic bearing device, comprising:
a sleeve;
a shaft that is relatively rotatably inserted in a bearing hole of the sleeve;
a radial bearing face having a dynamic pressure generation groove that is disposed on the outer peripheral face of the shaft and/or the inner peripheral face of the sleeve; and
a space formed between the shaft and the bearing hole of the sleeve that is filled with a lubricant as a working fluid;
wherein the sleeve is made from at least one kind of material selected from the group consisting of iron-based free-cutting steel, ferrite-based free-cutting stainless steel, and martensite-based free-cutting stainless steel, the length, in the axial direction of the bearing hole of the sleeve, of crystals of the free-cutting elements and free-cutting element alloys contained in each of the free-cutting steel is less than 0.03 mm, and the width in a direction perpendicular to the axial direction is less than 0.005 mm.

2. A fluid dynamic bearing device, comprising:
a sleeve;
a shaft that is relatively rotatably inserted in a bearing hole of the sleeve;
a radial bearing face having a dynamic pressure generation groove that is disposed on the outer peripheral face of the shaft and/or to the inner peripheral face of the sleeve; and
a space formed between the shaft and the bearing hole of the sleeve that is filled with a lubricant as a working fluid,
wherein the sleeve is made from at least one kind of material selected from among iron-based free-cutting steel, ferrite-based free-cutting stainless steel, and martensite-based free-cutting stainless steel, the carbon content of the free-cutting steel is less than 0.1 wt %, the hardness Hv (Vickers hardness) of the components formed from these materials is less than 230, and the bearing hole of the sleeve has a dynamic pressure generation groove formed by plastic working.
